(19) United States
(12) Patent Application Publication
(10) Pub. No.: US 2002/0178055 A1
(43) Pub. Date: Nov. 28, 2002

(54) Method for medical management account and referral reward system

(75) Inventor: William Kneebusch, Valley City, OH (US)

Correspondence Address: Daniel A. Thomson, Esq., One Cascade Plaza, Fourteenth Floor, Akron, OH, 44308-1136, US

(73) Assignee: Medcore Health System of Valley City, Ohio

(21) Appl. No.: 09/901,174

(22) Filed: Jul. 9, 2001

Related U.S. Application Data
(60) Provisional application No. 60/293,867, filed on May 25, 2001.

(51) Int. Cl. G06F 17/60

(52) U.S. Cl. 705/14; 705/2

(57) ABSTRACT

A new and improved method for medical management and referral reward system is described herein. The system allows individual members to enlist new members, thereby receiving reward benefits such as, monetary incentives as well as credits to a medical management account.

This application claims priority to U.S. Serial No. 60/293,867, entitled METHOD FOR MEDICAL MANAGEMENT ACCOUNT AND REFERRAL REWARD SYSTEM, filed May 25, 2001.

### I. BACKGROUND OF THE INVENTION

A. Field of the Invention

This invention relates to the art of healthcare management, and more particularly to the art of a reward system related to medical management.

B. Description of the Related Art

It is known in the art to provide cash back and other incentives related to particular industries, such as the airline reward points system, wherein the customer is rewarded with cash, airline coupons, and various other incentives for flying certain amounts of miles on a particular airline.

It is also known to develop a system of rewards and incentives for obtaining customers in the sales area, wherein individuals receive monetary awards and other incentives for initiating new memberships. However, none of the rewards systems reward an individual for referring new members to a medical insurance alternative. Also, none of the reward systems reward a member with medical expense credits.

The present invention provides a new and improved method for medical management and referral reward system, and overcomes certain difficulties inherent in the related inventions while providing better overall results.

### II. DEFINITIONS

Money—Something generally accepted as a medium of exchange, a measure of value, or a means of payment. The definition of money as used in this application also includes negotiable instruments, which are defined as, “an unconditional promise or order to pay a fixed amount of money, with or without interest or other charges described in the promise or to order, if it 1) is payable to a bearer or to order at the time it is issued or first comes into possession of a holder, 2) is payable on demand or at a definite time, and 3) does not state any other undertaking or instruction by the person promising or ordering payment to do any act in addition to the payment of money, but the promise or order may contain (i) an undertaking or power to give, maintain, or protect collateral to secure payments, (ii) an authorization or power to the holder to confess judgment or realize on or dispose of collateral, or (iii) a waiver of the benefit of any law intended for the advantage or protection of an obligor.”

### III SUMMARY OF THE INVENTION

In accordance with one aspect of the present invention, a method for medical management referral rewards includes providing access to a membership, initiating the membership, providing a health group, the health group consisting of three referral levels, the first level consisting of five referrals, the second level consisting of twenty-five referrals, and the third level consisting of one hundred twenty-five referrals, respectively, the referrals not being added to the second level until the first level is complete, the referrals not being added to the third level until both the first and the second levels are complete, transferring two dollars per month to a member for every first level referral, transferring two dollars per month to the member for every second level referral, transferring thirty-eight dollars per month to the member for every third level referral, transferring two dollars per month to a member medical management account for every first level referral, transferring two dollars per month to the account for every second level referral, transferring twenty dollars per month to the account for every third level referral, providing a new health group when the first, second, and third levels are complete, and repeating the steps as necessary.

In accordance with another aspect of the present invention, a medical management account referral reward system includes providing access to a medical management account membership, initiating the membership, providing a health group, the group consisting of multiple levels, a first level being filled with referrals before subsequent referrals are entered into a second level, transferring a first amount of money to a member for a referral to the first level after the referral initiates a medical management account membership, and transferring a second amount of money to the member for a referral to the second level after the referral initiates a medical management account membership, wherein the money is transferred on a periodic basis.

In accordance with still another aspect of the present invention, the method includes providing a health group, the group consisting of at least three levels, a first level being filled with referrals before subsequent referrals are entered into a second level, the second level being filled with referrals before subsequent referrals are entered into a third level, wherein the second level has more referral openings than the first level and the third level has more referral openings than the second level.

In accordance with yet another aspect of the present invention, the method includes, transferring a second amount of money to the member for a referral to the second level, transferring a third amount of money to the member for a referral to the third level after the referral initiates a medical management account membership, wherein the third amount is greater than the first and second amounts.

In accordance with another aspect of the present invention, the method includes providing a new health group when the first, second, and third levels are complete.

In accordance with still another aspect of the present invention, a medical management account referral reward system includes the steps of providing access to a medical management account membership, initiating the membership, and transferring an amount of medical expense credit to a member for a referral after the referral initiates a medical management account membership.

In accordance with yet another aspect of the present invention, the method includes the steps of providing a health group, the group consisting of multiple levels, a first level being filled with referrals before subsequent referrals are entered into a second level, transferring a first amount of medical expense credit to a member for a referral to the first level after the referral initiates a medical management account membership, transferring a second amount of medical expense credit to the member for a referral to the second level after the referral initiates a medical management account membership, and transferring a third amount of medical expense credit to the member for a referral to the third level after the referral initiates a medical management account membership.

In accordance with another aspect of the present invention, the system includes the steps of providing a health group, the group consisting of at least three levels, a first level being filled with referrals before subsequent referrals are entered into a second level, the second level being filled with referrals before subsequent referrals are entered into a third level.

In accordance with another aspect of the present invention, the system includes providing a new health group when the first, second, and third levels are complete.

In accordance with another aspect of the present invention, the system includes the steps of transferring a first amount of money to a member for every first level referral, transferring a second amount of money to the member for every second level referral, and transferring a third amount of money to the member for every third level referral, the money being transferred on a periodic basis.

In accordance with another aspect of the present invention, a computer readable medium includes providing access to a medical management account membership, initiating the membership, providing a health group, the group consisting of multiple levels, a first level being filled with referrals before subsequent referrals are entered into a second level, transferring a first amount of money to a member for a referral to the first level after the referral initiates a medical management account membership, and transferring a second amount of money to the member for a referral to the second level after the referral initiates a medical management account membership, wherein the money is transferred on a periodic basis.

In accordance with still another aspect of the present invention, the computer readable medium includes providing a health group, the group consisting of at least three levels, a first level being filled with referrals before subsequent referrals are entered into a second level, the second level being filled with referrals before subsequent referrals are entered into a third level, wherein the second level has more referral openings than the first level and the third level has more referral openings than the second level.

In accordance with yet another aspect of the present invention, the computer readable medium includes, transferring a second amount of money to the member for a referral to the second level, transferring a third amount of money to the member for a referral to the third level after the referral initiates a medical management account membership, wherein the third amount is greater than the first and second amounts.

In accordance with another aspect of the present invention, the computer readable medium includes providing a new health group when the first, second, and third levels are complete.

In accordance with still another aspect of the present invention, a computer readable medium includes the steps of providing access to a medical management account membership, initiating the membership, and transferring an amount of medical expense credit to a member for a referral after the referral initiates a medical management account membership.

In accordance with yet another aspect of the present invention, the computer readable medium includes the steps of providing a health group, the group consisting of multiple levels, a first level being filled with referrals before subsequent referrals are entered into a second level, transferring a first amount of medical expense credit to a member for a referral to the first level after the referral initiates a medical management account membership, transferring a second amount of medical expense credit to the member for a referral to the second level after the referral initiates a medical management account membership, and transferring a third amount of medical expense credit to the member for a referral to the third level after the referral initiates a medical management account membership.

In accordance with another aspect of the present invention, the computer readable medium includes the steps of providing a health group, the group consisting of at least three levels, a first level being filled with referrals before subsequent referrals are entered into a second level, the second level being filled with referrals before subsequent referrals are entered into a third level.

In accordance with another aspect of the present invention, the computer readable medium includes providing a new health group when the first, second, and third levels are complete.

In accordance with another aspect of the present invention, the computer readable medium includes the steps of transferring a first amount of money to a member for every first level referral, transferring a second amount of money to the member for every second level referral, and transferring a third amount of money to the member for every third level referral, the money being transferred on a periodic basis.

In accordance with another aspect of the present invention, an apparatus for rewarding medical management account referrals includes means for providing access to a medical management account membership, initiating the membership, means for providing a health group, the group consisting of multiple levels, a first level being filled with referrals before subsequent referrals are entered into a second level, means for transferring a first amount of money to a member for a referral to the first level after the referral initiates a medical management account membership, and means for transferring a second amount of money to the member for a referral to the second level after the referral initiates a medical management account membership, wherein the money is transferred on a periodic basis.

In accordance with still another aspect of the present invention, the method includes means for providing a health group, the group consisting of at least three levels, a first level being filled with referrals before subsequent referrals are entered into a second level, the second level being filled with referrals before subsequent referrals are entered into a third level, wherein the second level has more referral openings than the first level and the third level has more referral openings than the second level.

In accordance with yet another aspect of the present invention, the method includes, means for transferring a second amount of money to the member for a referral to the second level, means for transferring a third amount of money to the member for a referral to the third level after the referral initiates a medical management account membership, wherein the third amount is greater than the first and second amounts.

In accordance with another aspect of the present invention, the method includes means for providing a new health group when the first, second, and third levels are complete.

In accordance with still another aspect of the present invention, an apparatus includes means for providing access to a medical management account membership, means for initiating the membership, and means for transferring an amount of medical expense credit to a member for a referral after the referral initiates a medical management account membership.

In accordance with yet another aspect of the present invention, the apparatus includes means for providing a health group, the group consisting of multiple levels, a first level being filled with referrals before subsequent referrals are entered into a second level, means for transferring a first amount of medical expense credit to a member for a referral to the first level after the referral initiates a medical management account membership, means for transferring a second amount of medical expense credit to the member for a referral to the second level after the referral initiates a medical management account membership, and means for transferring a third amount of medical expense credit to the member for a referral to the third level after the referral initiates a medical management account membership.

In accordance with another aspect of the present invention, the apparatus includes means for providing a health group, the group consisting of at least three levels, a first level being filled with referrals before subsequent referrals are entered into a second level, the second level being filled with referrals before subsequent referrals are entered into a third level.

In accordance with another aspect of the present invention, the apparatus includes means for providing a new health group when the first, second, and third levels are complete.

In accordance with another aspect of the present invention, the apparatus includes means for transferring a first amount of money to a member for every first level referral, means for transferring a second amount of money to the member for every second level referral, and means for transferring a third amount of money to the member for every third level referral, the money being transferred on a periodic basis.

Still other benefits and advantages of the invention will become apparent to those skilled in the art upon reading and understanding of the following detailed specification.

### IV. BRIEF DESCRIPTION OF DRAWINGS

The invention is illustrated in the following drawings:

FIG. 1 is a diagram of the cash for referral system, showing the amounts for one embodiment;

FIG. 2 is a diagram of the medical management account, showing the amounts for one embodiment; and,

FIG. 3 is a diagram showing the inventive system, including the health group, the medical management account, and the cash for referral system.

### V. DESCRIPTION OF THE INVENTION

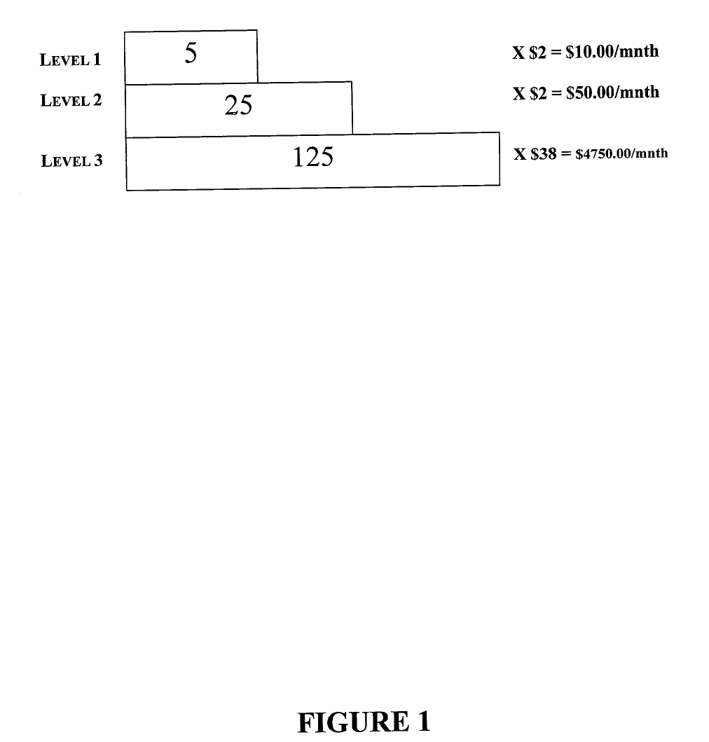

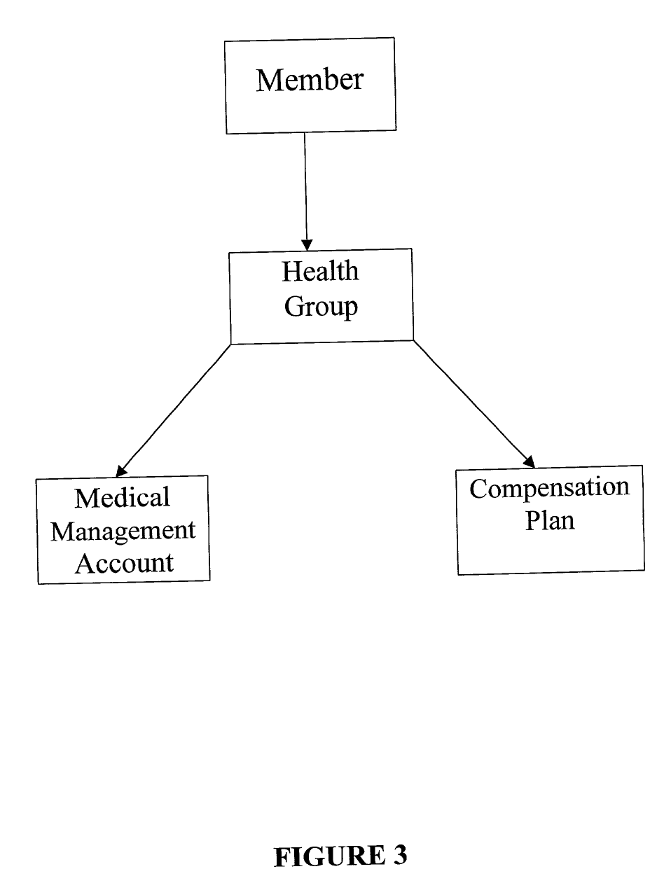

With reference to FIGS. 1-3 the inventive system, in this embodiment, offers services to the members who operate as independent health consultants. These consultants participate in a group health plan. The group health plan encourages the members to enroll new members, which in turn provides a benefit to the group as a whole. The inventive method allows the individual to sponsor as many new members as desired, and the plan automatically fills in the group with five enrollees on the first level and then automatically enrolls additional enrollees to the second level. In this embodiment, the reward program will pay through three levels.

The members receive monthly compensation based on the number of participants in their plan. In this embodiment, members are paid $2.00 per month for the members on level one, $2.00 per month for members on level two, and $38.00 per month for the members enrolled on level three. It is to be understood, that the amounts per month, as well as the frequency of payment are not intended to be a limitation to this invention, but are merely examples of one embodiment of this invention. Any amount of payment per referral, as well as any periodic basis can be used, as long as chosen using sound business judgment. Also, it is within the scope of this invention, that the member would be paid a one-time fee for each referral.

The group plan as shown in FIG. 1 is designed to allow five direct placements on the first level. Any additional members that are enrolled will be placed underneath members on the first level. This continues until the health group is complete with the three levels complete with five, twenty-five, and one hundred twenty-five, referrals, respectively, at which point, the individual can begin to build a second group. The inventive system is not limited to this embodiment. Any number of levels and groups can be filled, as long as using chosen sound business judgment.

The money paid to the member for each referral is not tied to the company in any manner, in that the member may use the money for anything they choose.

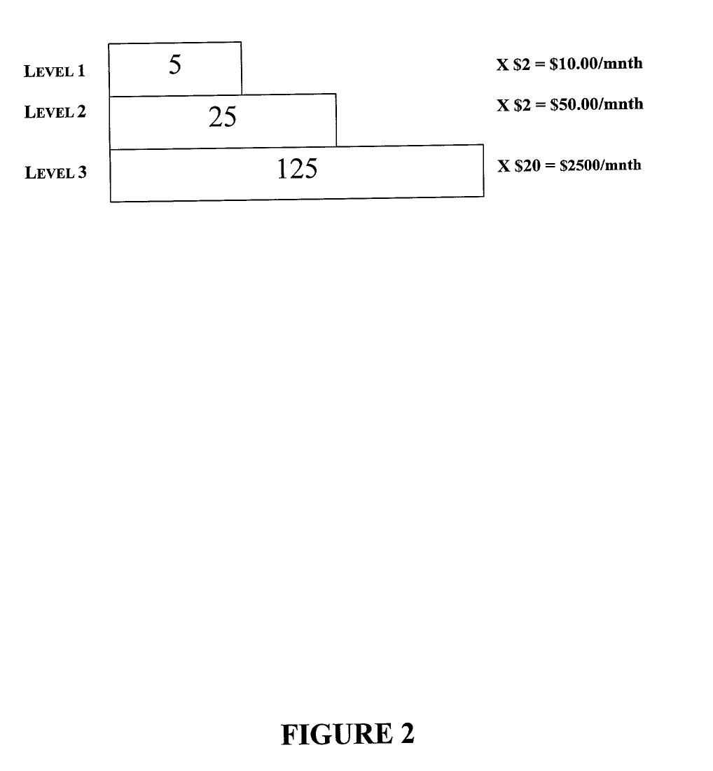

With reference now to FIG. 2, this embodiment of the inventive system is a program that works in addition to the above-referenced method. In this embodiment, each month, based on the size of the health group, the individual earns money, in the form of medical expense credits, in their medical management account. This money is held in reserve to offset any medically related expense. The member can submit their bills for reimbursement, and each month will receive 100% reimbursement for their expenses, up to the current balance of their account.

The medical management account allows the member to be reimbursed for any medically related expense including but not limited to, health management account premiums, membership dues, over the counter drugs, pain relievers, cough suppressants, cold and flu medicine, vitamins and minerals, health foods, podiatry care, masotherapy, dental care (i.e. tooth brushes, floss, paste), management account co-pays, management account deductibles, vision care, and the like. The previous list is intended to be an illustrative list only, and is not intended to limit the invention in any manner.

The method used in this embodiment is similar to the previous embodiment. The member must first establish a health group by recruiting new members. When the member has recruited someone, they are automatically enrolled in both the previous embodiment, and the medical management account program, and will begin receiving both cash rewards and medical expense credits.

It is to be understood that this embodiment in combination with the previous embodiment, is merely one manner of performing the invention. It is to be understood, that the inventive process can be separated into two separate embodiments, for example, the process could be used just for the cash referral system, or could be used just with the medical expense credits with a referral. The invention can be used in any combination of ways with these two embodiments as well as any combination of number of levels in health groups. For example, the cash referral system, as shown in FIG. 1, could have a different number of levels than the medical management account as shown in FIG. 2.

The health groups defined in the previous embodiments are made up of individuals that the member has either directly or indirectly enrolled in the system. The health group model is a tremendous benefit to the organization. By building a group of individuals, the member benefits the entire organization. The health group is built upon the concept of a three by three group. Each group will receive only three enrollees in the first level, and the levels will be only three levels deep. Every individual who sponsors a new member has their own group, and will receive the benefits of their group's success.

The inventive process as described in the previous embodiments, can be carried out as many times as necessary or desired. For example, there is no limit to the number of health groups that can be created by an individual member. Therefore, the process can continue indefinitely, as long as the member continues to provide referrals and new memberships.

It is to be understood that the embodiments mentioned-above, including the cash system as well as the medical management system, are merely embodiments of the invention and are not intended to limit it in any manner. Any system of reward benefits in the medical healthcare field is encompassed by this invention, and can be designed in any manner using sound business judgment.

The design of any software that would be used to perform or implement the inventive process, would be well within in this skill of one ordinary skilled in the art, and the description and identification of such software will not be further described herein.

It is to be understood that the different levels, the amounts, and the enrolled individuals per level, is not intended to limit this invention in any manner, but is merely one embodiment of the invention. Any number of participants, levels, and amounts, can be used as long as chosen using sound business judgment.

The invention has been described with reference to several embodiments. Obviously, modifications and alterations will occur to others upon a reading and understanding of the specification. It is intended by applicant to include all such modifications and alterations insofar as they come within the scope of the appended claims or the equivalents thereof.

Having thus described the invention, it is now claimed:

What is claimed is:

1. A method for medical management referral rewards, the method comprising the steps of:
a) providing access to a membership;
b) initiating the membership;
c) providing a health group, the health group consisting of three referral levels, the first level consisting of five referrals, the second level consisting of twenty-seven referrals, and the third level consisting of one hundred twenty-five referrals, respectively, the referrals not being added to the second level until the first level is complete, the referrals not being added to the third level until both the first and the second levels are complete;
d) transferring two dollars per month to a member for every first level referral;
e) transferring two dollars per month to the member for every second level referral;
f) transferring thirty-eight dollars per month to the member for every third level referral;
g) transferring two dollars per month to a member medical management account for every first level referral;
h) transferring two dollars per month to the account for every second level referral;
i) transferring twenty dollars per month to the account for every third level referral;
j) providing a new health group when the first, second, and third levels are complete; and,
k) repeating steps d) through j).

2. A medical management account referral reward system, the system comprising the steps of:
a) providing access to a medical management account membership;
b) initiating the membership;
c) providing a health group, the group consisting of multiple levels;
d) transferring a first amount of money to a member for a referral to the first level after the referral initiates a medical management account membership; and,
e) transferring a second amount of money to the member for a referral to the second level after the referral initiates a medical management account membership.

3. The system of claim 2, wherein the money is transferred on a periodic basis.

4. The system of claim 3, wherein providing a health group, the group consisting of multiple levels comprises the step of:
providing a health group, the group consisting of multiple levels, a first level being filled with referrals before subsequent referrals are entered into a second level.

5. The system of claim 4, wherein providing a health group, the group consisting of multiple levels, a first level being filled with referrals before subsequent referrals are entered into a second level comprises the step of:
providing a health group, the group consisting of multiple levels, a first level being filled with referrals before subsequent referrals are entered into a second level, the second level having more referral openings than the first level.

6. The system of claim 5, wherein providing a health group, the group consisting of multiple levels, a first level being filled with referrals before subsequent referrals are entered into a second level comprises the step of:
e) providing a health group, the group consisting of at least three levels, a first level being filled with referrals before subsequent referrals are entered into a second level, the second level being filled with referrals before subsequent referrals are entered into a third level.

7. The system of claim 6, wherein the third level has more referral openings than the second level.

8. The system of claim 7, wherein the system further comprises the steps of:
f) transferring a third amount of money to the member for a referral to the third level after the referral initiates a medical management account membership.

9. The system of claim 8, wherein the third amount of money is greater than the first and second amounts of money.

10. The system of claim 9, wherein the money is transferred monthly.

11. The system of claim 10, wherein the system further comprises the steps of:
providing a new health group when the first, second, and third levels are complete; and,
repeating the steps d) through f).

12. A medical management account referral reward system, the system comprising the steps of:
a) providing access to a medical management account membership;
b) initiating the membership; and,
c) transferring an amount of medical expense credit to a member for a referral after the referral initiates a medical management account membership.

13. The system of claim 12, wherein transferring an amount of medical expense credit to a member for a referral after the referral initiates a medical management account membership comprises the steps of:
c) providing a health group, the group consisting of multiple levels;
d) transferring a first amount of medical expense credit to a member for a referral to the first level after the referral initiates a medical management account membership; and,
e) transferring a second amount of medical expense credit to the member for a referral to the second level after the referral initiates a medical management account membership.

14. The system of claim 13, wherein the credit is transferred on a periodic basis.

15. The system of claim 14, wherein providing a health group, the group consisting of multiple levels comprises the step of:
providing a health group, the group consisting of multiple levels, a first level being filled with referrals before subsequent referrals are entered into a second level

16. The system of claim 15, wherein providing a health group, the group consisting of multiple levels, a first level being filled with referrals before subsequent referrals are entered into a second level comprises the step of:
providing a health group, the group consisting of multiple levels, a first level being filled with referrals before subsequent referrals are entered into a second level, the second level having more referral openings than the first level.

17. The system of claim 16, wherein providing a health group, the group consisting of multiple levels, a first level being filled with referrals before subsequent referrals are entered into a second level comprises the step of:
providing a health group, the group consisting of at least three levels, a first level being filled with referrals before subsequent referrals are entered into a second level, the second level being filled with referrals before subsequent referrals are entered into a third level.

18. The system of claim 17, wherein the third level has more referral openings than the second level.

19. The system of claim 18, wherein the system further comprises the steps of:
f) transferring a third amount of medical expense credit to the member for a referral to the third level after the referral initiates a medical management account membership.

20. The system of claim 19, wherein the third amount of credit is greater than the second amount of credit.

21. The system of claim 20, wherein the credit is transferred monthly.

22. The system of claim 21, wherein the system further comprises the steps of:
g) providing a new health group when the first, second, and third levels are complete; and,
repeating the steps d) through g).

23. The system of claim 20, wherein the method further comprises the steps of:
transferring a first amount of money to a member for every first level referral;
transferring a second amount of money to the member for every second level referral; and,
transferring a third amount of money to the member for every third level referral, the money being transferred on a periodic basis.

24. A computer readable medium containing instructions for controlling a computer system to perform a method, the method comprising the steps of:
a) providing access to a medical management account membership;
b) initiating the membership; and,
c) transferring an amount of medical expense credit to a member for a referral after the referral initiates a medical management account membership.

25. The computer readable medium of claim 24, wherein transferring an amount of medical expense credit to a member for a referral after the referral initiates a medical management account membership comprises the steps of:
c) providing a health group, the group consisting of multiple levels;
d) transferring a first amount of medical expense credit to a member for a referral to the first level after the referral initiates a medical management account membership; and,
e) transferring a second amount of medical expense credit to the member for a referral to the second level after the referral initiates a medical management account membership.

26. The computer readable medium of claim 25, wherein the credit is transferred on a periodic basis.

27. The computer readable medium of claim 26, wherein providing a health group, the group consisting of multiple levels comprises the step of:
providing a health group, the group consisting of multiple levels, a first level being filled with referrals before subsequent referrals are entered into a second level.

28. The computer readable medium of claim 27, wherein providing a health group, the group consisting of multiple levels, a first level being filled with referrals before subsequent referrals are entered into a second level comprises the step of:
providing a health group, the group consisting of multiple levels, a first level being filled with referrals before subsequent referrals are entered into a second level, the second level having more referral openings than the first level.

29. The computer readable medium of claim 28, wherein providing a health group, the group consisting of multiple levels, a first level being filled with referrals before subsequent referrals are entered into a second level comprises the step of:
providing a health group, the group consisting of at least three levels, a first level being filled with referrals before subsequent referrals are entered into a second level, the second level being filled with referrals before subsequent referrals are entered into a third level.

30. The computer readable medium of claim 29, wherein the third level has more referral openings than the second level.

31. The computer readable medium of claim 30, wherein the system further comprises the steps of:
f) transferring a third amount of medical expense credit to the member for a referral to the third level after the referral initiates a medical management account membership.

32. The computer readable medium of claim 31, wherein the third amount of credit is greater than the second amount of credit.

33. The computer readable medium of claim 32, wherein the credit is transferred monthly.

34. The computer readable medium of claim 33, wherein the system further comprises the steps of:
g) providing a new health group when the first, second, and third levels are complete; and,
repeating the steps d) through g).

35. The computer readable medium of claim 32, wherein the method further comprises the steps of:
transferring a first amount of money to a member for every first level referral;
transferring a second amount of money to the member for every second level referral; and,
transferring a third amount of money to the member for every third level referral, the money being transferred on a periodic basis.

36. An apparatus for rewarding medical management account referrals, the apparatus comprising:
a) means for providing access to a medical management account membership;
b) means for initiating the membership; and,
c) means for transferring an amount of medical expense credit to a member for a referral after the referral initiates a medical management account membership.

37. The apparatus of claim 36, wherein means for transferring an amount of medical expense credit to a member for a referral after the referral initiates a medical management account membership comprises:
c) means for providing a health group, the group consisting of multiple levels;
d) means for transferring a first amount of medical expense credit to a member for a referral to the first level after the referral initiates a medical management account membership; and,
e) means for transferring a second amount of medical expense credit to the member for a referral to the second level after the referral initiates a medical management account membership.

38. The apparatus of claim 37, wherein the credit is transferred on a periodic basis.

39. The apparatus of claim 38, wherein means for providing a health group, the group consisting of multiple levels further comprises:
means for providing a health group, the group consisting of multiple levels, a first level being filled with referrals before subsequent referrals are entered into a second level.

40. The apparatus of claim 39, wherein means for providing a health group, the group consisting of multiple levels, a first level being filled with referrals before subsequent referrals are entered into a second level comprises:
means for providing a health group, the group consisting of multiple levels, a first level being filled with referrals before subsequent referrals are entered into a second level, the second level having more referral openings than the first level.

41. The apparatus of claim 40, wherein means for providing a health group, the group consisting of multiple levels, a first level being filled with referrals before subsequent referrals are entered into a second level comprises:
means for providing a health group, the group consisting of at least three levels, a first level being filled with referrals before subsequent referrals are entered into a second level, the second level being filled with referrals before subsequent referrals are entered into a third level.

42. The apparatus of claim 41, wherein the third level has more referral openings than the second level.

43. The apparatus of claim 42, wherein the apparatus further comprises:
f) means for transferring a third amount of medical expense credit to the member for a referral to the third level after the referral initiates a medical management account membership.

44. The apparatus of claim 42, wherein the third amount of credit is greater than the second amount of credit.

45. The apparatus of claim 44, wherein the credit is transferred monthly.

46. The apparatus of claim 45, wherein the apparatus further comprises:
g) means for providing a new health group when the first, second, and third levels are complete; and,
means for repeating the steps d) through g).

47. The apparatus of claim 44, wherein the apparatus further comprises:
means for transferring a first amount of money to a member for every first level referral;
means for transferring a second amount of money to the member for every second level referral; and,
means for transferring a third amount of money to the member for every third level referral, the money being transferred on a periodic basis.
